(19) United States
(12) Patent Application Publication
(10) Pub. No.: US 2023/0419822 A1
(43) Pub. Date: Dec. 28, 2023

(54) TRAFFIC EVENT DETECTION APPARATUS, TRAFFIC EVENT DETECTION SYSTEM, METHOD AND COMPUTER READABLE MEDIUM

(71) Applicant: NEC Corporation, Minato-ku, Tokyo (JP)

(72) Inventors: Murtuza Petladwala, Tokyo (JP); Tomoyuki Hino, Tokyo (JP)

(73) Assignee: NEC Corporation, Minato-ku, Tokyo (JP)

(21) Appl. No.: 18/036,858

(22) PCT Filed: Nov. 24, 2020
(86) PCT No.: PCT/JP2020/043683

§ 371 Date: May 12, 2023

(51) Int. Cl. G08G 1/01

(52) U.S. Cl. CPC G08G 1/0116; G08G 1/0133

(57) ABSTRACT

An object of the present disclosure is to provide a traffic event detection apparatus, traffic event detection system, a method and a non-transitory computer readable medium capable of detecting traffic events correctly. A traffic event detection apparatus includes at least one memory configured to store instructions and at least one processor configured to execute the instructions to: estimate a trajectory of a moving object based on an oscillation signal by using deep neural network, while the oscillation signal is induced by traffic of the moving object; extract a timestamp of the moving object based on the trajectory of the moving object; and extract a part of the oscillation signal corresponding to the timestamp of the moving object.

### TECHNICAL FIELD

The present disclosure relates to a traffic event detection apparatus, a traffic event detection system, a method and a non-transitory computer readable medium.

### BACKGROUND ART

Monitoring system for infrastructures such as roads or railroads has been developed recently.

For example, Patent Literature 1 (PTL 1) discloses railroad monitoring system. This railroad monitoring system includes communication optical fibers laid in a railroad and a detection unit which detects a pattern in accordance with the state of the railroad. Thereby, the railroad monitoring system can detect abnormality in the railroad.

### CITATION LIST

### Patent Literature

PTL 1: WO 2020/116031 A1

### SUMMARY OF INVENTION

### Technical Problem

To analyze infrastructures such as roads or railroads correctly, it is desirable to distinguish each of vehicles or pedestrians passing by the infrastructures. PTL 1 discloses how to predict the abnormality in the railroad, however, it does not disclose this problem.

An object of the present disclosure is to provide a traffic event detection apparatus, a traffic event detection system, a method and a non-transitory computer readable medium capable of detecting traffic events correctly.

### Solution to Problem

According to a first aspect of the disclosure, there is provided a traffic event detection apparatus that includes: a trajectory estimation means for estimating a trajectory of a moving object based on an oscillation signal by using deep neural network, while the oscillation signal is induced by traffic of the moving object; a timestamp extraction means for extracting a timestamp of the moving object based on the trajectory of the moving object; and an event extraction means for extracting a part of the oscillation signal corresponding to the timestamp of the moving object.

According to a second aspect of the disclosure, there is provided a traffic event detection system comprising that includes: a sensor; and a traffic event detection apparatus; wherein the traffic event detection apparatus includes; a trajectory estimation means for estimating a trajectory of a moving object based on an oscillation signal by using deep neural network, while the oscillation signal is induced by traffic of the moving object and detected by the sensor; a timestamp extraction means for extracting a timestamp of the moving object based on the trajectory of the moving object; and an event extraction means for extracting a part of the oscillation signal corresponding to the timestamp of the moving object.

According to a third aspect of the disclosure, there is provided a traffic event detection method that includes: estimating a trajectory of a moving object based on an oscillation signal by using deep neural network, while the oscillation signal is induced by traffic of the moving object; extracting a timestamp of the moving object based on the trajectory of the moving object; and extracting a part of the oscillation signal corresponding to the timestamp of the moving object.

According to a fourth aspect of the disclosure, there is provided a non-transitory computer readable medium storing a program for causing a computer to execute: estimating a trajectory of a moving object based on an oscillation signal by using deep neural network, while the oscillation signal is induced by traffic of the moving object; extracting a timestamp of the moving object based on the trajectory of the moving object; and extracting a part of the oscillation signal corresponding to the timestamp of the moving object.

### Advantageous Effects of Invention

According to the present disclosure, it is possible to provide an object of the present disclosure is to provide a traffic event detection apparatus, a traffic event detection system, a method and a non-transitory computer readable medium capable of detecting traffic events correctly.

### BRIEF DESCRIPTION OF DRAWINGS

FIG. 1 is a block diagram of a traffic event detection apparatus according to a first example embodiment.

FIG. 2 is a flowchart illustrating a method of the traffic event detection apparatus according to the first example embodiment.

FIG. 3 illustrates a traffic event detection system and a side view of a road according to a second example embodiment.

FIG. 4 is a block diagram of a traffic event detection apparatus according to the second example embodiment.

FIG. 5A is an example of a time-distance graph according to the second example embodiment.

FIG. 5B is an example signal of raw dataset according to the second example embodiment.

FIG. 6 is a flowchart illustrating a method of the traffic event detection apparatus according to the second example embodiment.

FIG. 7A is an example of a diagram of vehicles according to the second example embodiment.

FIG. 7B is an example of a diagram of vehicles according to the second example embodiment.

FIG. 7C illustrates an example of an event set by timestamps according to the second example embodiment.

FIG. 8 is a block diagram of a computer apparatus according to embodiments.

### DESCRIPTION OF EMBODIMENTS

### (Outline of Related Art)

Prior to explaining embodiments according to this present disclosure, an outline of related art is explained.

Regarding detection using a response measured on a passing vehicle over a road or highway, Huiyong Liu, Jihui Ma, Wenfa Yan, Wensheng Liu, Xi Zhang, Congcong Li, “Traffic Flow Detection Using Distributed Fiber Optic Acoustic Sensing”, IEEE Access, Sep. 3, 2018, Volume 6, p. 68968-68980 (hereinafter referred to as Non-Patent Literature (NPL) 1) discloses a traffic flow detection algorithm that takes distributed fiber optic acoustics response data (time histories) of the road under traffic load and detects vehicle presence and calculates vehicle speed. The traffic flow detection algorithm of NPL 1 gives information about traffic events, such as detection of in and out timestamps of vehicles that have passed during an interval of time. Wavelet threshold denoising and the dual-threshold method are also disclosed in NPL 1, while they give in and out timestamps of the vehicles in the response data measured at designated locations on the fiber cable. As illustrated in FIG. 11 of NPL 1, in and out timestamps of the vehicles or traffic events are calculated by the wavelet threshold denoising method, which comprises of three steps, signal wavelet decomposition, threshold processing of wavelet coefficients, and signal reconstruction after the threshold processing. The dual-threshold method uses short-term energy and short-term zero crossing rate to determine whether a vehicle is passing in the response data.

Arslan Basharat, Necati Catbas, Mubarak Shah, “A Framework for Intelligent Sensor Network with Video Camera for Structural Health Monitoring of Bridges” Third IEEE International Conference on Pervasive Computing and Communications Workshops, Mar. 8-12, 2005 (hereinafter referred to as NPL 2) discloses a wireless sensor network framework that triggers smart events from local sensor data. The traffic events are useful for both intelligent data recording and video camera control. The operation of this framework consists of active & passive sensing modes. In these modes, measurements of traffic events are triggered by camera sensors configured with synchronized timestamps of the local sensors providing in and out timestamps of the vehicle in the response data.

WO 2017/072505 A1 (hereinafter referred to as Related Patent Literature (RPTL) 1) discloses the detection of traffic events and traffic flow parameters. Specifically, its abstract says, “The measurement signals from the sensing portions are processed to detect vehicles travelling on a road and to determine at least one traffic flow property”. The measurement signals in RPTL 1 can be called as waterfall data.

Given the related art mentioned above, the following analysis is made by the inventors of the present disclosure.

The traffic flow detection algorithm disclosed in NPL1 can detect an individual vehicle and its in and out timestamps in a specified monitoring location region from point A to point B. However, it is time-consuming to detect traffic events (especially for searching in and out timestamps) from huge dataset. Further, the disclosed detection algorithm in NPL 1 is sensitive to different types of structures, environment and weather conditions, which may provide incorrect traffic event details. Also, if there are multiple monitoring regions in a highway, it requires additional parameter calibration for the detection algorithm. The wireless sensor network framework disclosed in NPL 2 is also difficult to locate throughout the road or highway for multiple monitoring regions due to confined space in infrastructures like bridges and tunnels.

Accordingly, it is one of objects of the present disclosure to provide a traffic event detection apparatus, a traffic event detection system, a method and a non-transitory computer readable medium to detect traffic events in time series. Specifically, the present disclosure can provide an apparatus which enables to detect and extract traffic events in the multiple monitoring regions of the road or highway. Further, even in confined infrastructure spaces like bridges and tunnels, the apparatus makes it possible to monitor infrastructure health.

It should be noted that in the description of this disclosure, elements described using the singular forms such as “a,” “an” and “the” may be multiple elements unless explicitly stated.

### First Example Embodiment

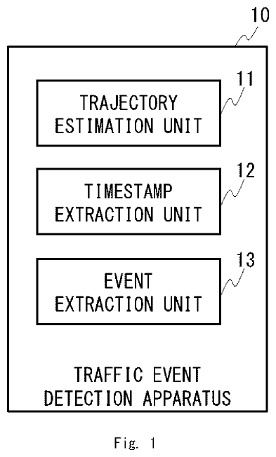

First, a traffic event detection apparatus 10 according to a first example embodiment of the present disclosure is explained with reference to FIG. 1.

Referring to FIG. 1, the traffic event detection apparatus 10 includes a trajectory estimation unit 11, a timestamp extraction unit 12 and an event extraction unit 13. The traffic event detection apparatus 10 is, for example, a computer or a machine. As an example, at least one of components in the traffic event detection apparatus 10 can be installed in a computer as a combination of one or a plurality of memories and one or a plurality of processors.

The trajectory estimation unit 11 estimates a trajectory of a moving object based on an oscillation signal by using deep neural network, while the oscillation signal is induced (caused) by traffic of the moving object. The moving object may be a vehicle, train, pedestrian (walking person) or the like. The trajectory may include position information and corresponding time information of the moving object.

The oscillation signal may be induced in a sensor, cable, wire and such as materials located in an infrastructure, such as a road, bridge, tunnel and so on, and may be detected by a sensor. Further, the sensor and the traffic event detection apparatus 10 can compose a traffic event detection system. The oscillation signal has amplitude of waves and it may be acoustics or vibration data. The deep neural network system may be installed in the traffic event detection apparatus 10, however, it may be installed in another computer. In the latter case, the trajectory estimation unit 11 can send the oscillation signal data to the another computer and order it to estimate the trajectory of the moving object. After the estimation, it sends back the result of the estimation, namely the trajectory of the moving object, to the traffic event detection apparatus 10.

The timestamp extraction unit 12 extracts one or a plurality of timestamp (timestamp(s)) of the moving object based on the trajectory of the moving object. For example, the timestamp(s) may denote the beginning and/or the end of a traffic event of the moving object in a particular pre-specified location or region of the infrastructure.

The event extraction unit 13 extracts a part of the oscillation signal corresponding to the timestamp(s) of the moving object. In this way, the traffic event detection apparatus 10 can correctly detect a traffic event of the moving object from the oscillation signal.

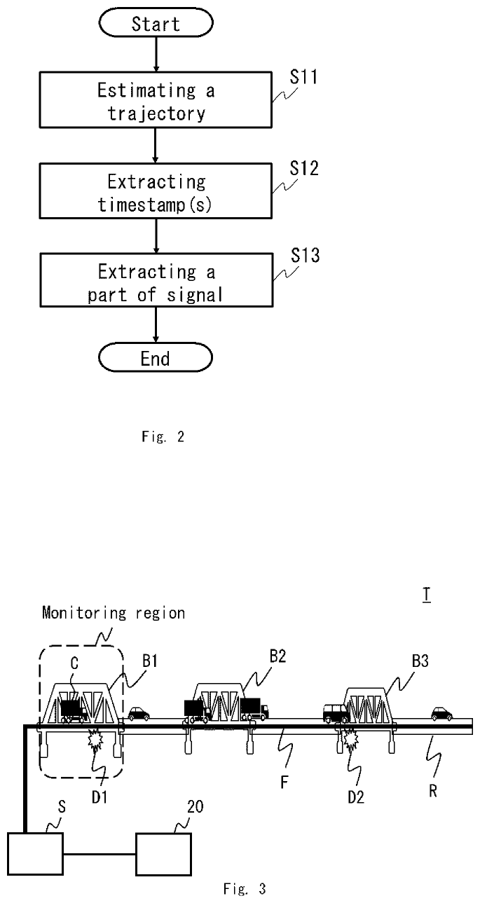

Next, referring to the flowchart in FIG. 2, an example of the operation of the present example embodiment will be described.

First, the trajectory estimation unit 11 estimates a trajectory of a moving object based on an oscillation signal by using deep neural network, while the oscillation signal is induced by traffic of the moving object (step S11).

Next, the timestamp extraction unit 12 extracts timestamp(s) of the moving object based on the trajectory of the moving object (step S12). Then, the event extraction unit 13 extracts a part of the oscillation signal corresponding to the timestamp(s) of the moving object (step S13).

It should be noted that the traffic event detection apparatus 10 may process these steps for not only a single moving object but also each of the plurality of moving objects.

As the traffic event detection apparatus 10 uses the estimated trajectory by using deep neural network, it can extract exact timestamp(s) of the moving object.

Therefore, the traffic event detection apparatus 10 can detect traffic events of the moving object correctly.

### Second Example Embodiment

Next, a second example embodiment of this disclosure will be described below referring to the accompanying drawings. This second example embodiment explains one of the specific examples of the first example embodiment, however, specific examples of the first example embodiment are not limited to this example embodiment.

FIG. 3 illustrates a traffic event detection system T that includes an optical fiber cable F (sensing optical fiber), a sensor S (sensing device) and a traffic event detection apparatus 20. Besides, FIG. 3 shows a schematic illustration of a side view of a road R with the optical fiber cable F placed along the road R. The optical fiber cable F is distributed along the road R and used for measuring response oscillation of the road R due to vehicles shown in FIG. 3, which pass along the optical fiber cable F. Further, the optical fiber cable F includes a plurality of sensing portions.

The road includes bridges B1, B2 and B3 and the vehicles pass these bridges from the left side to the right side in FIG. 3. The optical fiber cable F is provided under each of the bridges. The bridge B1 has a deterioration point D1 and the bridge B2 has a deterioration point D2. In this example, as explained below, the traffic event detection apparatus 20 monitors a monitoring region including the bridge B1 and can detect each traffic event of the vehicles and condition of the bridge B1, especially the deterioration point D1. The monitoring region is aligned by the location on the horizontal axis. In FIG. 3, a vehicle C is passing the bridge B1 and a trajectory of the vehicle C is recorded as explained below.

An oscillation signal (for example, acoustics or vibration data) is induced in the optical fiber cable F by the vehicles (especially by axles of the vehicles passing on the road R with the optical fiber cable). That is, the oscillation signal represents oscillation on the road R. The sensor S (sensing device) detects the oscillation signal at each of the plurality of sensing portions of the optical fiber cable F. The sensor S is able to detect the oscillation signal of the road R (target object) induced by axles of a vehicle, when the vehicle is passing on any traffic lane of the road R. The sensor S transmits the oscillation signal in digital data via wired communication to the traffic event detection apparatus 20. However, the communication between the sensor S and the traffic event detection apparatus 20 can be done by wireless communication.

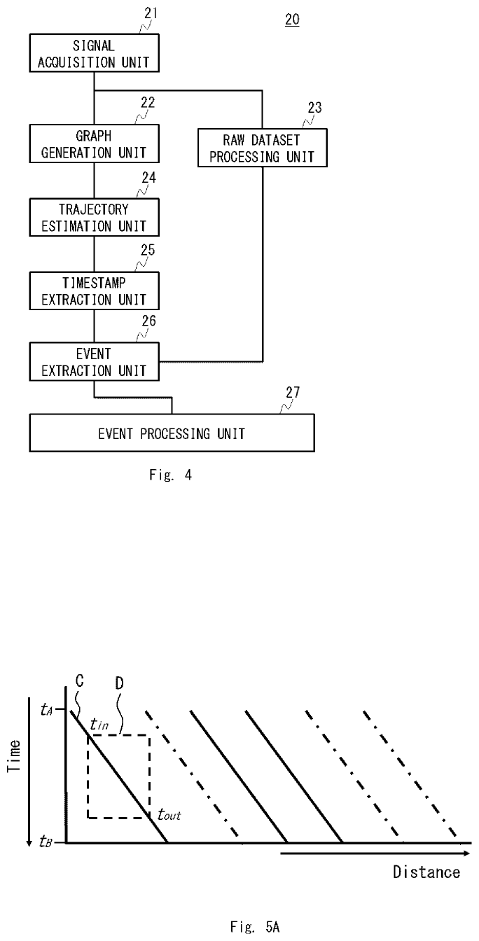

FIG. 4 shows the structure of the traffic event detection apparatus 20. Referring to FIG. 4, the traffic event detection apparatus 20 includes a signal acquisition unit 21, a graph generation unit 22 (waterfall dataset processing unit), a raw dataset processing unit 23, a trajectory estimation unit 24, a timestamp extraction unit 25, an event extraction unit 26 and an event processing unit 27. The traffic event detection apparatus 20 is one specific example of the traffic event detection apparatus 10 and it may include other units for computation. Each unit of the traffic event detection apparatus 20 will be explained in detail.

The signal acquisition unit 21 functions as an interface of the traffic event detection apparatus 20 and acquires the oscillation signal from the sensor S. The signal acquisition unit 21 outputs the oscillation signal to the graph generation unit 22 and the raw dataset processing unit 23. Furthermore, the signal acquisition unit 21 may preprocess the oscillation signal, if necessary. For example, the signal acquisition unit 21 may filter the oscillation signal and output the filtered oscillation signal.

The graph generation unit 22 calculates a time-distance graph from the oscillation signal for each of the plurality of sensing portions of the optical fiber cable F by applying sum of absolute intensities to a window of a predetermined length of the oscillation signal. The data which consists of the time-distance graph is also referred to as waterfall dataset in the disclosure. The graph generation unit 22 outputs the time-distance graph data to the trajectory estimation unit 24.

FIG. 5A illustrates an example snap of the waterfall dataset. The time-distance graph shown in FIG. 5A shows the waterfall dataset from time t_{A} to time t_{B}. Each line in FIG. 5A shows each trajectory of the vehicle on the road R in FIG. 3 and each line type represents each type of the vehicle, e.g. whether the vehicle is a passenger car or truck. In this example, vehicles are running along the road R (the optical fiber cable F) and going away from the sensor S. Vibration intensities of the optical fiber cable F (the oscillation signal) are visible, which are proportional to the type of the vehicle passing on the road R. In FIG. 5A, the high-vibration intensity of the vehicle is shown as solid lines and the low-vibration intensity of the vehicle is shown as dash-dotted lines.

The dashed box D in FIG. 5A represents the monitoring region from time-in tᵢₙ to time-out tₒᵤₜ. The time-in tᵢₙ represents the time when a vehicle has entered the monitoring region and time-out tₒᵤₜ represents the time when the vehicle has exited the monitoring region. In this case, the time-in tᵢₙ represents the time when the vehicle C starts to pass the bridge B1 (monitoring region) and the time-out tₒᵤₜ represents the time when the vehicle ends to pass the bridge B1. Consequently, the box D represents the trajectory of the vehicle C passing the bridge B1.

Referring back to FIG. 4, the raw dataset processing unit 23 calculates the oscillation signal (for example, the filtered oscillation signal) for each of the plurality of sensing portions of the optical fiber cable F and outputs the result of the calculation, i.e. raw oscillation signal corresponding to each location on the optical fiber cable F, to the event extraction unit.

The trajectory estimation unit 24 estimates a mask matrix using TrafficNet model. The mask matrix represents trajectories of each of the vehicles present in the time-distance graph. A unique value in the mask matrix represents each vehicle presence in the particular row and column. Further, the row and column of the mask matrix respectively represent time and distance indices of the waterfall dataset. The TrafficNet model is a deep neural network model that outputs the mask matrix of the input time-distance graph. The trajectory estimation unit 24 outputs the mask matrix data to the timestamp extraction unit 25.

The timestamp extraction unit 25 extracts the time-in tᵢₙ and time-out tₒᵤₜ of each of vehicles from the pre-specified monitoring region on the time-distance graph by linearly mapping the column indices of the mask matrix to its corresponding row indices for each vehicle trajectory. The timestamp extraction unit 25 outputs the data of these timestamps to the event extraction unit 26.

The event extraction unit 26 extracts a part of the raw dataset (the oscillation signal) using the tᵢₙ and tₒᵤₜ timestamps calculated by the timestamp extraction unit 25. A single slice of the raw data sliced by the tᵢₙ and tₒᵤₜ timestamps represents a single event, which might include a single or multiple vehicles vibrations that passed on the road. In this case, the single slice of the raw data corresponds to the event that a target vehicle passed the pre-specified monitoring region. The event extraction unit 26 outputs the extracted events to the event processing unit 27.

FIG. 5B illustrates an example signal of the raw dataset. The dashed box in FIG. 5B represents an event in the monitoring region from the time-in tᵢₙ to the time-out tₒᵤₜ. In this example, the event shows the vehicle C passed the bridge B1 during the period from the time-in tᵢₙ to the time-out tₒᵤₜ.

Referring back to FIG. 4, the event processing unit 27 processes the events extracted by the event extraction unit 26 to estimate infrastructure properties and/or traffic flow properties. One example of the infrastructure properties may be structure health of the bridge B1 and one example of the traffic flow properties may be the number of the vehicle(s) passing on each lane of the road R. Moreover, the event-wise raw dataset is used in frequency analysis of the structure responses with various traffic loads. Any conventional art can be applied to the detailed processing of the event processing unit 27.

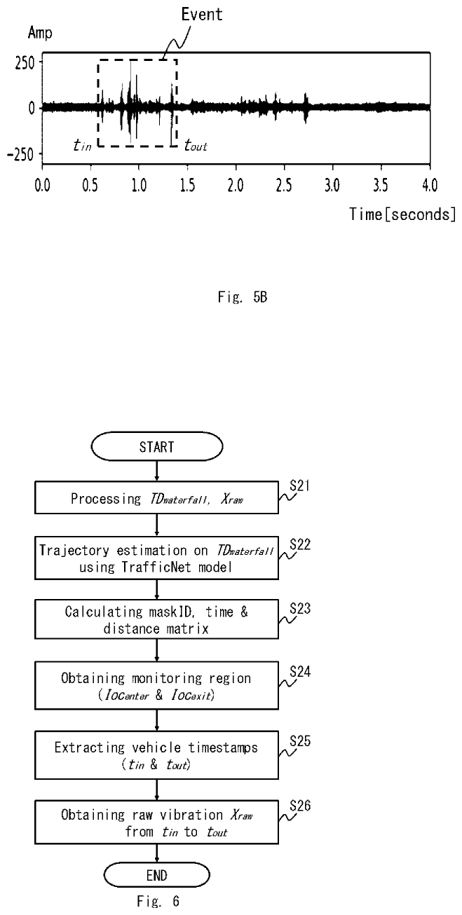

FIG. 6 is a flow chart illustrating an operation example of the traffic event detection apparatus 20 which estimates traffic events by vehicles' trajectories and obtains the raw dataset.

First, the signal acquisition unit 21 receives the oscillation signal from the sensor S. The graph generation unit 22 and the raw dataset processing unit 23 processes the time-distance graph (hereinafter referred to as TD_{waterfall}) and the raw oscillation signal data (hereinafter referred to as X_{raw}) respectively (step S21). Specifically, as mentioned before, the graph generation unit 22 generates the TD_{waterfall} (diagram of vehicles) from the oscillation signal for each of the plurality of sensing portions of the optical fiber cable F, and the raw dataset processing unit 23 outputs the X_{raw} corresponding to each location on the optical fiber cable F.

The trajectory estimation unit 24 estimates the TD_{waterfall} and generates the mask matrix using TrafficNet model (step S22). The TrafficNet model is the deep neural network capable of generating the mask matrix of the TD_{waterfall}. In this way, the trajectory estimation unit 24 estimates trajectories of the vehicles as a form of the mask matrix.

The timestamp extraction unit 25 calculates the 3-column matrix based on the mask matrix generated by the trajectory estimation unit 24 (step S23). In the 3-column matrix, a first column shows mask numbers (mask IDs) of each vehicle and a second column shows time and a third column shows distances (e.g. distances in meters away from the sensor S) of a particular vehicle extracted from trajectories. The timestamp extraction unit 25 can generate a plurality of the 3-column matrices according to the number of measurement timing of the sensor S.

The 3-column matrix can be also referred as a compressed sparse matrix retrieved from the mask matrix. The following are examples of the 3-column matrices;
(a) time: 0

$$\begin{matrix}\begin{matrix}mask ID & time & distance\end{matrix} \\ ( \begin{matrix}1 & 0 & 0 \\ 2 & 0 & 10 \\ 3 & 0 & 20 \\ … & … & … \\ N & 0 & loc\end{matrix} )\end{matrix}$$

(b) time: 0.2

$$\begin{matrix}\begin{matrix}mask ID & time & distance\end{matrix} \\ ( \begin{matrix}1 & 0.2 & 4 \\ 2 & 0.2 & 14 \\ 3 & 0.2 & 24 \\ … & … & … \\ N & 0.2 & loc\end{matrix} )\end{matrix}$$

(c) time: t

$$\begin{matrix}\begin{matrix}mask ID & time & distance\end{matrix} \\ ( \begin{matrix}1 & t & d 1 \\ 2 & t & d 2 \\ 3 & t & d 3 \\ … & … & … \\ N & t & loc\end{matrix} )\end{matrix}$$

where,
N=the number of vehicles,
t=total time elapsed from the start, and
loc=location on the time-distance graph.

Based on the example of the compressed sparse matrix, a vehicle of interest (target vehicle) may be selected by the mask ID for the following processing.

The timestamp extraction unit 25 obtains the pre-specified entry locₑₙₜₑᵣ and exit locₑₓᵢₜ locations provided as the parameter for the monitoring region (step S24). The data of the pre-specified entry locₑₙₜₑᵣ and exit locₑₓᵢₜ may be stored in the traffic event detection apparatus 20.

The timestamp extraction unit 25 extracts the event timestamps tᵢₙ and tₒᵤₜ corresponding to the locₑₙₜₑᵣ and locₑₓᵢₜ from the compressed sparse matrices of the particular vehicle of interest (step S25). As noted above, the compressed sparse matrices are obtained at step S23.

The event extraction unit 26 obtains the raw dataset X_{raw} from the raw dataset processing unit 23 and slice it by using the timestamps tᵢₙ and tₒᵤₜ (step S26). In this manner the event extraction unit 26 obtains a single slice of the raw data representing a single event. The event extraction unit 26 outputs the extracted events to the event processing unit 27. The event processing unit 27 estimates structure health of the road R (for example bridge B1 in FIG. 3) and estimates traffic flow properties by using the event extracted by the event extraction unit 26. For example, the event processing unit 27 can analyze the event to detect the existence of the deterioration point D1 and/or estimate the degree of deterioration of the deterioration point D1.

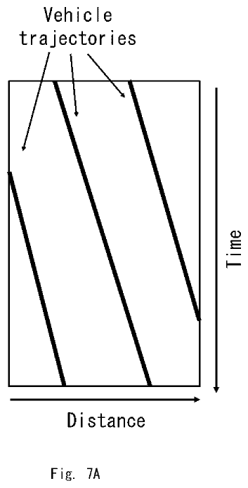

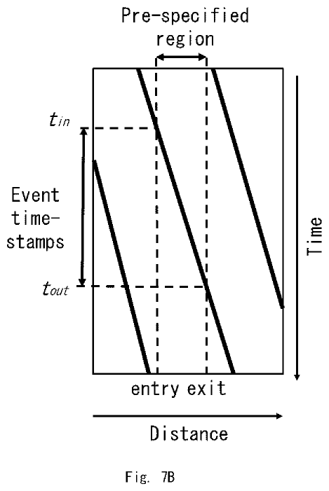

FIGS. 7A to 7C show examples of the data generated through processing steps in FIG. 6. FIG. 7A shows an example of the diagram of vehicles time-distance graph generated by the graph generation unit 22 at step S21. Lines in FIG. 7A represent each of vehicle trajectories.

FIG. 7B shows the pre-specified monitoring region and the event timestamps tᵢₙ and tₒᵤₜ in the diagram of vehicles time-distance graph, while the pre-specified monitoring region is defined by the entry locₑₙₜₑᵣ and exit locₑₓᵢₜ locations. The parameter for the monitoring region is set at step S24 and the event timestamps tᵢₙ and tₒᵤₜ are set at step S25 by the timestamp extraction unit 25.

FIG. 7C illustrates an example of an event set by the timestamps tᵢₙ and tₒᵤₜ. In FIG. 7C, the event is extracted by slicing the raw dataset with the timestamps tᵢₙ and tₒᵤₜ. The event extraction unit 26 processes this extraction at step S25.

The traffic event detection apparatus 20 can detect traffic events (especially for searching in and out timestamps) from huge dataset with less time, since the traffic event detection apparatus 20 can specify trajectories by the TrafficNet model. Further, even in confined infrastructure spaces like bridges and tunnels, the traffic event detection apparatus 20 makes it possible to monitor infrastructure health.

In this example embodiment, the graph generation unit 22 generates the time-distance graph based on the oscillation signal, and the trajectory estimation unit 24 estimates the trajectory of the moving object present in the time-distance graph by the deep neural network. As the time-distance graph is easy to process, therefore, the traffic event detection apparatus 20 can estimate the trajectory with less computation.

In this example embodiment, the graph generation unit 22 generates the time-distance graph by applying sum of absolute intensities to the window of a predetermined length of the oscillation signal. Since the graph generation unit 22 uses the precise way, therefore, the traffic event detection apparatus 20 can detect trajectories correctly.

In this example embodiment, the event processing unit 27 (event monitoring means) monitors a traffic event based on the part of the oscillation signal. As a result, the event processing unit 27 can analyze properties of an infrastructure passed by the moving object and/or traffic flow properties. In this way, the traffic event detection apparatus 20 can obtain more correct result of the analysis.

In this example embodiment, the trajectory estimation unit 24 estimates a mask matrix of the time-distance graph by applying the deep neural network model. Therefore, the traffic event detection apparatus 20 can process calculation using the mask matrix in an easy way.

In this example embodiment, the timestamp extraction unit 25 extracts in and out timestamps of the moving object on the time-distance graph, and the event extraction unit 26 extracts the part of the oscillation signal corresponding to the in and out timestamps of the moving object. Therefore, the traffic event detection apparatus 20 can extract the event corresponding to the part of the oscillation signal.

In this example embodiment, the traffic event detection system T includes the optical fiber cable F and the sensor S detects the oscillation signal of the optical fiber cable F. Therefore, the traffic event detection system T can obtain data regarding various kinds of infrastructures where the optical fiber cable can be installed.

In this example embodiment, the oscillation signal is induced by axles of a vehicle passing on a road with the optical fiber cable F. Therefore, the traffic event detection apparatus 20 can detect the traffic events of the vehicle.

Each disclosure of the above-listed RPTL 1 and NPLs 1-2 is incorporated herein by reference. Modification and adjustment of each example embodiment and each example are possible within the scope of the overall disclosure (including the claims) of the present disclosure and based on the basic technical concept of the present disclosure. The present embodiments are, therefore, to be considered in all respects to be illustrative and not restrictive.

For example, in the second example embodiment, the optical fiber cable F is placed along the road R. However, the optical fiber cable F can be placed along a highway, railway, or other kinds of infrastructures. A plurality of the monitoring region may be, of course, set by the traffic event detection apparatus 20.

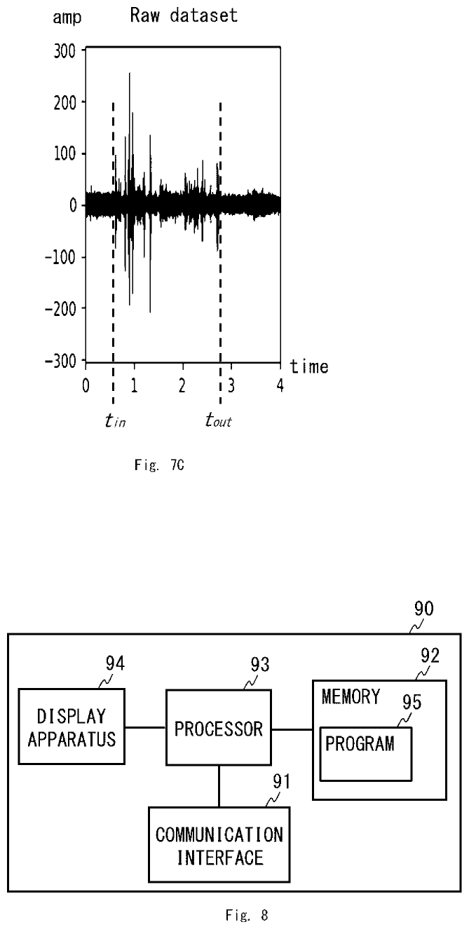

Next, a configuration example of the traffic event detection apparatus explained in the above-described plurality of embodiments is explained hereinafter with reference to FIG. 8.

The traffic event detection apparatus, which includes both examples of the traffic event detection apparatus 10 and the traffic event detection apparatus 20, may be implemented on a computer system as illustrated in FIG. 8. Referring to FIG. 8, a computer apparatus 90, such as a server or the like, includes a communication interface 91, a memory 92, a processor 93 and a display apparatus 94.

The communication interface 91 (e.g. a network interface controller (NIC)) may be configured to communicatively connect to sensor(s) provided in an infrastructure. For example, as shown in FIG. 3, the sensor(s) may be provided under lanes of a bridge. Furthermore, the communication interface 91 may communicate with other computer(s) and/or machine(s) to receive and/or send data related to the computation of the computer apparatus.

The memory 92 stores program 95 (program instructions) to enable the computer apparatus 90 to function as the traffic event detection apparatus 10 or the traffic event detection apparatus 20. The memory 92 includes, for example, a semiconductor memory (for example, Random Access Memory (RAM), Read Only Memory (ROM), Electrically Erasable and Programmable ROM (EEPROM), and/or a storage device including at least one of Hard Disk Drive (HDD), SSD (Solid State Drive), Compact Disc (CD), Digital Versatile Disc (DVD) and so forth. From another point of view, the memory 92 is formed by a volatile memory and/or a nonvolatile memory. The memory 92 may include a storage disposed apart from the processor 93. In this case, the processor 93 may access the memory 92 through an I/O interface (not shown).

The processor 93 is configured to read the program 95 (program instructions) from the memory 92 to execute the program 95 (program instructions) to realize the functions and processes of the above-described plurality of embodiments. The processor 93 may be, for example, a microprocessor, an MPU (Micro Processing Unit), or a CPU (Central Processing Unit). Furthermore, the processor 93 may include a plurality of processors. In this case, each of the processors executes one or a plurality of programs including a group of instructions to cause a computer to perform an algorithm explained above with reference to the drawings.

The display apparatus 94 can display the extracted event, the infrastructure properties and/or traffic flow properties estimated by the event processing unit 27. In one example, the display apparatus 94 can display the result of the detection of the number of the vehicle(s) passing on each lane. In another example, the display apparatus 94 can display the structure health of the bridge B1.

The program 95 includes program instructions (program modules) for executing processing of each unit of the traffic event detection apparatus in the above-described plurality of embodiments.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), Compact Disc (CD) (e.g. CD-ROM (Compact Disc Read Only Memory), CD-R (Compact Disc Recordable), CD-R/W (Compact Disc Rewritable)), Digital Versatile Disc (DVD) and semiconductor memories (such as ROM, mask ROM, PROM (Programmable ROM), EPROM (Erasable PROM), Electrically and Erasable Programmable Read Only Memory (EEPROM)), flash ROM, RAM (Random Access Memory), Hard Disk Drive (HDD), Solid State Drive (SSD), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Part of or all the foregoing embodiments can be described as in the following appendixes, but the present disclosure is not limited thereto.

### (Supplementary Note 1)

A traffic event detection apparatus comprising:
a trajectory estimation means for estimating a trajectory of a moving object based on an oscillation signal by using deep neural network, while the oscillation signal is induced by traffic of the moving object;
a timestamp extraction means for extracting a timestamp of the moving object based on the trajectory of the moving object; and
an event extraction means for extracting a part of the oscillation signal corresponding to the timestamp of the moving object.

### (Supplementary Note 2)

The traffic event detection apparatus according to Supplementary Note 1, further comprising;
a graph generation means for generating a time-distance graph based on the oscillation signal; and wherein
the trajectory estimation means estimates the trajectory of the moving object present in the time-distance graph by using the deep neural network.

### (Supplementary Note 3)

The traffic event detection apparatus according to Supplementary Note 2, wherein the graph generation means generates the time-distance graph by applying sum of absolute intensities to a window of a predetermined length of the oscillation signal.

### (Supplementary Note 4)

The traffic event detection apparatus according to any one of Supplementary Notes 1 to 3, further comprising;
an event monitoring means for monitoring a traffic event based on the part of the oscillation signal.

### (Supplementary Note 5)

The traffic event detection apparatus according to Supplementary Note 4, wherein the event monitoring means monitors the traffic event to analyze properties of an infrastructure passed by the moving object and/or traffic flow properties.

### (Supplementary Note 6)

The traffic event detection apparatus according to any one of Supplementary Notes 1 to 5, wherein
the trajectory estimation means estimates a mask matrix representing the trajectory of the moving object; and
the timestamp extraction means extracts the timestamp using the mask matrix.

### (Supplementary Note 7)

The traffic event detection apparatus according to any one of Supplementary Notes 1 to 6, wherein
the timestamp extraction means extracts in and out timestamps of the moving object; and
the event extraction means extracts the part of the oscillation signal corresponding to the in and out timestamps of the moving object.

### (Supplementary Note 8)

A traffic event detection system comprising:
a sensor; and
a traffic event detection apparatus;
wherein the traffic event detection apparatus includes;
a trajectory estimation means for estimating a trajectory of a moving object based on an oscillation signal by using deep neural network, while the oscillation signal is induced by traffic of the moving object and detected by the sensor;
a timestamp extraction means for extracting a timestamp of the moving object based on the trajectory of the moving object; and
an event extraction means for extracting a part of the oscillation signal corresponding to the timestamp of the moving object.

### (Supplementary Note 9)

The traffic event detection system according to Supplementary Note 8, further comprising:
an optical fiber cable; and wherein
the sensor detects the oscillation signal of the optical fiber cable.

### (Supplementary Note 10)

The traffic event detection system according to Supplementary Note 9, wherein the oscillation signal is induced by axles of a vehicle passing on a road with the optical fiber cable.

### (Supplementary Note 11)

A traffic event detection method comprising:
estimating a trajectory of a moving object based on an oscillation signal by using deep neural network, while the oscillation signal is induced by traffic of the moving object;
extracting a timestamp of the moving object based on the trajectory of the moving object; and
extracting a part of the oscillation signal corresponding to the timestamp of the moving object.

### (Supplementary Note 12)

A non-transitory computer readable medium storing a program for causing a computer to execute:
estimating a trajectory of a moving object based on an oscillation signal by using deep neural network, while the oscillation signal is induced by traffic of the moving object;
extracting a timestamp of the moving object based on the trajectory of the moving object; and
extracting a part of the oscillation signal corresponding to the timestamp of the moving object.

Various combinations and selections of various disclosed elements (including each element in each Supplementary Note, each element in each example, each element in each drawing, and the like) are possible within the scope of the claims of the present disclosure. That is, the present disclosure naturally includes various variations and modifications that could be made by those skilled in the art according to the overall disclosure including the claims and the technical concept.

### REFERENCE SIGNS LIST

10 TRAFFIC EVENT DETECTION APPARATUS
11 TRAJECTORY ESTIMATION UNIT
12 TIMESTAMP EXTRACTION UNIT
13 EVENT EXTRACTION UNIT
20 TRAFFIC EVENT DETECTION APPARATUS
21 SIGNAL ACQUISITION UNIT
22 GRAPH GENERATION UNIT
23 RAW DATASET PROCESSING UNIT
24 TRAJECTORY ESTIMATION UNIT
25 TIMESTAMP EXTRACTION UNIT
26 EVENT EXTRACTION UNIT
27 EVENT PROCESSING UNIT
F OPTICAL FIBER CABLE
S SENSOR
T TRAFFIC EVENT DETECTION SYSTEM
90 COMPUTER APPARATUS
91 COMMUNICATION INTERFACE
92 MEMORY
93 PROCESSOR
94 DISPLAY APPARATUS
95 PROGRAM

What is claimed is:

1. A traffic event detection apparatus comprising:
at least one memory configured to store instructions; and
at least one processor configured to execute the instructions to:
estimate a trajectory of a moving object based on an oscillation signal by using deep neural network, while the oscillation signal is induced by traffic of the moving object;
extract a timestamp of the moving object based on the trajectory of the moving object; and
extract a part of the oscillation signal corresponding to the timestamp of the moving object.

2. The traffic event detection apparatus according to claim 1, wherein the at least one processor is further configured to:
generate a time-distance graph based on the oscillation signal; and
estimate the trajectory of the moving object present in the time-distance graph by using the deep neural network.

3. The traffic event detection apparatus according to claim 2, wherein the at least one processor is further configured to
generate the time-distance graph by applying sum of absolute intensities to a window of a predetermined length of the oscillation signal.

4. The traffic event detection apparatus according to claim 1, wherein the at least one processor is further configured to monitor a traffic event based on the part of the oscillation signal.

5. The traffic event detection apparatus according to claim 4, wherein the at least one processor is further configured to
monitoring means monitor the traffic event to analyze properties of an infrastructure passed by the moving object and/or traffic flow properties.

6. The traffic event detection apparatus according to claim 1, wherein the at least one processor is further configured to:
estimate a mask matrix representing the trajectory of the moving object; and
extract the timestamp using the mask matrix.

7. The traffic event detection apparatus according to claim 1, wherein the at least one processor is further configured to:
extract in and out timestamps of the moving object; and
extract the part of the oscillation signal corresponding to the in and out timestamps of the moving object.

8. A traffic event detection system comprising:
a sensor; and
a traffic event detection apparatus;
wherein the traffic event detection apparatus includes;
at least one memory configured to store instructions; and
at least one processor configured to execute the instructions to:
estimate a trajectory of a moving object based on an oscillation signal by using deep neural network, while the oscillation signal is induced by traffic of the moving object and detected by the sensor;
extract a timestamp of the moving object based on the trajectory of the moving object; and
extract a part of the oscillation signal corresponding to the timestamp of the moving object.

9. The traffic event detection system according to claim 8, further comprising:
an optical fiber cable; and wherein
the sensor detects the oscillation signal of the optical fiber cable.

10. The traffic event detection system according to claim 9, wherein
the oscillation signal is induced by axles of a vehicle passing on a road with the optical fiber cable.

11. A traffic event detection method performed by a computer comprising:
estimating a trajectory of a moving object based on an oscillation signal by using deep neural network, while the oscillation signal is induced by traffic of the moving object;
extracting a timestamp of the moving object based on the trajectory of the moving object; and
extracting a part of the oscillation signal corresponding to the timestamp of the moving object.

12. A non-transitory computer readable medium storing a program for causing a computer to execute:
estimating a trajectory of a moving object based on an oscillation signal by using deep neural network, while the oscillation signal is induced by traffic of the moving object;
extracting a timestamp of the moving object based on the trajectory of the moving object; and
extracting a part of the oscillation signal corresponding to the timestamp of the moving object.
